(19) United States
(12) Patent Application Publication
(10) Pub. No.: US 2023/0199003 A1
(43) Pub. Date: Jun. 22, 2023

(54) MACHINE LEARNING-BASED SECURITY ALERT ISSUANCE BASED ON ACTIONABILITY METRICS

(71) Applicant: Microsoft Technology Licensing, LLC, Redmond, WA (US)

(72) Inventors: Andrey KARPOVSKY, Kiryat Motzkin (IL); Roy LEVIN, Haifa (IL); Tamer SALMAN, Haifa (IL)

(21) Appl. No.: 17/556,279

(22) Filed: Dec. 20, 2021

(51) Int. Cl. H04L 9/40; G06N 20/00

(52) U.S. Cl. CPC H04L 63/1416; G06N 20/00; H04L 63/1433; H04L 63/1441

(57) ABSTRACT

The embodiments described herein are directed to generating labels for alerts and utilizing such labels to train a machine learning algorithm for generating more accurate alerts. For instance, alerts may be generated based on log data generated from an application. After an alert is issued, activity of a user in relation to the alert is tracked. The tracked activity is utilized to generate a metric for the alert indicating a level of interaction between the user and the alert. Based on the metric, the log data on which the alert is based is labeled as being indicative of one of suspicious activity or benign activity. During a training process, the labeled log data is provided to a supervised machine learning algorithm that learns what constitutes suspicious activity or benign activity. The algorithm generates a model, which is configured to receive newly-generated log data and issue security alerts based thereon.

### BACKGROUND

In security domains, features are deployed in order to monitor a customer’s cloud service perimeter for potential malicious activity. In case of a potential vulnerability or attack on a resource, the situation is communicated to the resource owner. Usually, it is done in the format of an alert (in case of ongoing attack) or recommendation (in case of an existing vulnerability that is yet to be exploited). An issue arises when the alerts inaccurately or mistakenly indicate malicious activity. A user will lose trust in the alert system and will be less likely to act upon the alert. As such, when a valid alert is issued, the user may fail to act on the alert, thereby jeopardizing the user’s systems and data.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer-readable storage mediums described herein are configured to generate labels for alerts and utilize such labels to train a supervised machine learning algorithm for generating more accurate security alerts. For instance, alerts may be generated based on log data generated from an application. After an alert is issued to a user, activity of the user in relation to the alert is tracked. The tracked activity is utilized to generate an actionability metric for the alert, which indicates a level of interaction between the user and the first alert. The log data on which the alert is based is labeled as being indicative of one of suspicious activity or benign activity using the actionability metric. In certain cases, the determined actionability metric itself may be utilized as the label (e.g., in the absence of benign/malicious indicators). During a training process, the labeled log data is provided as training data to a supervised machine learning algorithm that learns what constitutes suspicious activity or benign activity. The algorithm generates a machine learning model based on the training process, which is configured to receive newly-generated log data and issue security alerts based thereon.

Further features and advantages, as well as the structure and operation of various example embodiments, are described in detail below with reference to the accompanying drawings. It is noted that the example implementations are not limited to the specific embodiments described herein. Such example embodiments are presented herein for illustrative purposes only. Additional implementations will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate example embodiments of the present application and, together with the description, further serve to explain the principles of the example embodiments and to enable a person skilled in the pertinent art to make and use the example embodiments.

FIG. 1 shows a block diagram of an example system configured to generate labels based on alerts and train a machine learning algorithm for generating improved alerts based on such labels in accordance with an example embodiment.

FIG. 2 shows a flowchart of a method for generating labels based on alerts and training a machine learning algorithm for generating improved alerts based on such labels in accordance with an example embodiment.

FIG. 3 depicts a block diagram of a system configured to track activity performed by a user with respect to an alert in accordance with an example embodiment.

FIG. 4 shows a flowchart of a method for generating an actionability metric in accordance with an example embodiment.

FIG. 5 shows a flowchart of a method for generating an actionability metric in accordance with another example embodiment.

FIG. 6 shows a flowchart of a method for generating an actionability metric in accordance with a further example embodiment.

FIG. 7 is a block diagram of an example processor-based computer system that may be used to implement various embodiments.

The features and advantages of the implementations described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose numerous example implementations. The scope of the present application is not limited to the disclosed implementations, but also encompasses combinations of the disclosed implementations, as well as modifications to the disclosed implementations. References in the specification to “one implementation,” “an implementation,” “an example embodiment,” “example implementation,” or the like, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of persons skilled in the relevant art(s) to implement such feature, structure, or characteristic in connection with other implementations whether or not explicitly described.

In the discussion, unless otherwise stated, terms such as “substantially” and “about” modifying a condition or relationship characteristic of a feature or features of an implementation of the disclosure, should be understood to mean that the condition or characteristic is defined to within tolerances that are acceptable for operation of the implementation for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Numerous example embodiments are described as follows. It is noted that any section/subsection headings provided herein are not intended to be limiting. Implementations are described throughout this document, and any type of implementation may be included under any section/subsection. Furthermore, implementations disclosed in any section/subsection may be combined with any other implementations described in the same section/subsection and/or a different section/subsection in any manner.

### II. Example Implementations

It is important for alerts to include as much as possible relevant data and provide easy and clear mitigation steps. However, it is also important to not overburden the alert with too many extra details that will obfuscate the initial message. This is resolved by including some initial information and mitigation steps, and providing links to additional details, documentation, remediation options, etc.

A major problem with developing high quality security features is the lack of labels that label an alert as actually being directed to suspicious activity. There are multiple reasons for this; namely skewness of data (a majority of events are legitimate) and a lack of reliable and complete feedback from customers. The feedback is rare because the alert may not be understood correctly by the customer, the alert is ignored altogether, or the customers are reluctant to publicly acknowledge existing security flaws. This makes maintenance and improvement of the quality of alerts challenging, since often a problem in accuracy or usefulness of an alert is unknown. In addition, this prevents the application of supervised machine learning-based approaches in developing the features, thus leaving many existing advanced algorithms unreachable.

The embodiments described herein are directed to generating labels for alerts and utilizing such labels to train a supervised machine learning algorithm for generating more accurate security alerts. For instance, alerts may be generated based on log data generated from an application. After an alert is issued to a user, activity of the user in relation to the alert is tracked. The tracked activity is utilized to generate an actionability metric for the alert, which indicates a level of interaction between the user and the first alert. The log data on which the alert is based is labeled as being indicative of one of suspicious activity or benign activity using the actionability metric. In certain cases, the determined actionability metric itself may be utilized as the label (e.g., in the absence of benign/malicious indicators). During a training process, the labeled log data is provided as training data to a supervised machine learning algorithm that learns what constitutes suspicious activity or benign activity. The algorithm generates a machine learning model based on the training process, which is configured to receive newly-generated log data and issue security alerts based thereon.

As supervised machine-learning based techniques generally provide more accurate classifications than other techniques, such as unsupervised machine-learning based techniques, the embodiments described herein advantageously improve the accuracy of security, thereby minimizing the likelihood of false positives. Thus, a user is more likely to act on such alerts and perform the necessary mitigating actions to prevent the suspicious activity identified by the alerts. Failure to act on such alerts may result in the user’s computing system to be infected with malware, result in the user’s data to be stolen and/or encrypted, and/or result any type of activity that can impair the user’s computing system. Accordingly, the techniques described herein advantageously improve the technical field of data security.

In addition, the techniques described herein also improve the functioning of computing devices that generate such alerts and/or receive such alerts. For instance, as described above, the number of false positive security alerts is reduced, thereby reducing the overall number of alerts that are issued. Accordingly, computing devices no longer need to expend compute resources (e.g., processing cycles, memory, storage, input/output (I/O) transactions, power, etc.) to generate such alerts and/or receive and display such alerts. Still further, the false positive security alerts may cause the user to unnecessarily consume compute computing device resources, e.g., by initiating anti-malware/virus applications. Such expenditure of resources is mitigated in accordance with the techniques described herein.

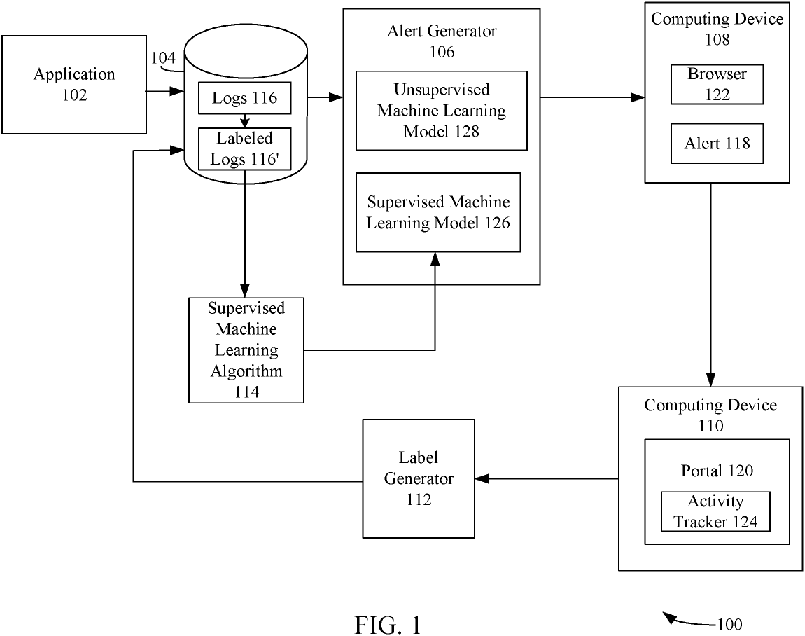

FIG. 1 shows a block diagram of an example system 100 configured to generate labels based on alerts and train a machine learning algorithm for generating improved alerts based on such labels, according to an example embodiment. As shown in FIG. 1, system 100 includes an application 102, a data store 104, an alert generator 106, a computing device 108, a computing device 110, a label generator 112, and a supervised machine learning algorithm 114. Application 102, data store 104, alert generator 106, computing device 108, computing device 110, label generator 112, and/or supervised machine learning algorithm 114 may be communicatively coupled via one or more networks. Examples of such network(s) include, but are not limited to, local area networks (LANs), wide area networks (WANs), enterprise networks, the Internet, etc., and may include one or more of wired and/or wireless portions. System 100 is described as follows.

Application 102, alert generator 106, label generator 112, and/or supervised machine learning algorithm 114 may be installed and/or executed on a computing device (e.g., computing device 108). The computing device may be executed on an on-premise computing device (e.g., a computing device that is located and/or maintained on the premise of the user of application 102) or may be a remotely-located server (or “node”) or a virtual machine instantiated on the server. The server may be incorporated as part of a cloud-based platform. In accordance with at least one embodiment, the cloud-based platform comprises part of the Microsoft® Azure® cloud computing platform, owned by Microsoft Corporation of Redmond, Washington, although this is only an example and not intended to be limiting. An example of application 102 includes, but is not limited to, a database server application, including, but not limited to Microsoft® Azure SQL Database™ published by Microsoft® Corporation of Redmond, Washington. Each of application 102, alert generator 106, label generator 112, and/or supervised machine learning algorithm 114 may be incorporated into a single application and/or web service. Alternatively, any of application 102, alert generator 106, label generator 112, and/or supervised machine learning algorithm 114 may each be incorporated into a different application and/or web service.

Application 102 is configured to execute statements to create, modify, and delete data file(s) based on an incoming query. Queries may be user-initiated or automatically generated by one or more background processes. Such queries may be configured to add data file(s), merge data file(s) into a larger data file, re-organize (or re-cluster) data file(s) (e.g., based on a commonality of data file(s)) within a particular set of data file, delete data file(s) (e.g., via a garbage collection process that periodically deletes unwanted or obsolete data), etc.

Application 102 is configured to generates logs 116 during execution thereof. Logs 104 comprise data that describe event that have occurred with respect to particular resourcs emanaged and/or accessed by application 102. Examples of resources include, but are not limited to, data files, database tables, database directories, database table rows, structured data, unstructured data, semi-structured data, a data container, etc. The log data comprises details about the event, such as an identifier of a resource that was accessed, an identifier (e.g., an Internet Protocol (IP) address) of an entity that accessed the resource, the time at which the resource was accessed, one or more queries executed to access the resource, an amount of resources (e.g., a number of rows) that was accessed for any given query, etc. Logs 104 may be structured as rows within one or more database tables, where each row corresponds to a particular query transaction and each column in a row stores one or more of the log data described herein.

Application 102 stores logs 116 in data store 104. Data store 104 may be a stand-alone storage system, and/or may be internally or externally associated with application 102. Data store 104 may be any type of storage device or array of devices, and while shown as being communicatively coupled to application 102, may be networked storage that is accessible via network(s), as described above. Data store 104 may be configured to store one or more databases or data sets, which are configured to store logs 116. Such logs 116 may be queryable by other entities, such as, but not limited to, alert generator 106.

Alert generator 106 is configured to analyze logs 116 to determine whether any suspicious activity has occurred with respect to application 102 and/or the resource(s) managed and/or accessed thereby and issue an alert 118. An example of suspicious activity includes access and/or utilization of application 102 and/or its associated resources from an unknown entity or location. For instance, alert generator 106 may determine whether logs 116 include IP addresses that are not included in an allow list or IP addresses that have not been utilized to access and/or utilize application 102 and its resources in the past. Another example of suspicious activity includes accessing an abnormal amount of resources or accessing the resources in an abnormal way. For instance, alert generator 106 may compare past resource query patterns to the query patterns identified in logs 116 to detect query patterns that are atypical (e.g., accessing a relatively large amount of data, performing a particular pattern of read and/or write queries to a particular resource, etc.). In accordance with an embodiment, alert generator 106 may comprise an unsupervised machine learning model 128 configured to detect suspicious activity. During a training process, unsupervised machine learning algorithm 114 is provided previously-generated logs (e.g., historical logs that were generated over the course of several days, weeks, months, etc.) as a training set. Using the training set, unsupervised machine learning model 128 self-discovers normally-occurring patterns and learns what constitutes suspicious activity or benign activity. Unsupervised machine learning model 128 may output a probability score indicative of a likelihood that suspicious activity was performed. Alert generator 106 may generate an alert 118 responsive to the probability score reaching or exceeding a predetermined threshold (e.g., 0.85). Examples of unsupervised machine learning algorithms that may be utilized include, but are not limited to, clustering-based algorithms (e.g., hierarchical clustering, k-means clustering, mixture model-based clustering, etc.), anomaly detection-based algorithms, neural network-based algorithms, etc. It is noted that other techniques may be utilized to generate alerts, including, but not limited to, a rules-based approach in which predetermined rules are applied to the log data to detect suspicious activity.

Alerts (shown as alert 118) may be provided to a computing device (e.g., computing device 108) of a user (e.g., an administrator, and end user, etc.). Alert 118 may comprise a short messaging service (SMS) message, a telephone call, an e-mail, a notification that is presented via an incident management service, etc. Computing device 108 may be any type of stationary or mobile (or handheld) computing device, including a mobile computer or mobile computing device (e.g., a Microsoft® Surface® device, a laptop computer, a notebook computer, a tablet computer such as an Apple iPad™, a netbook, etc.), a wearable computing device (e.g., a head-mounted device including smart glasses such as Google® Glass™, etc.), or a stationary computing device such as a desktop computer or PC (personal computer). In accordance with an embodiment, application 102 and/or alert generator 106 execute on computing device 108, and data store 104 is incorporated with computing device 108.

Alert 118 may comprise an identifier (e.g., the name) of application 102, an identifier of the resource (e.g., the name or ID (e.g., table ID, row ID, etc.)), a uniform resource identifier (e.g., a uniform resource locator (URL) of a web-based portal 120, etc. Web-based portal 120 may comprise a web site by which a customer may deploy, access and/or manage application 102 and its associated resources. Web-based portal 120 may be accessible via a browser application 122 executing on computing device 108. An example of web-based portal 120 includes, but is not limited to, Microsoft® Azure® Portal published by Microsoft® Corporation.

Web-based portal 120 may be hosted on a computing device 110. Computing device 110 may comprise a server computer, a server system, etc. Computing device 110 may be included, for example, in a network-accessible server infrastructure. In an embodiment, computing device 110 may form a network-accessible server set, such as a cloud computing server network. For example, computing device 110 may comprise a group or collection of servers (e.g., computing devices) that are each accessible via a network such as the Internet (e.g., in a cloud-based platform) to store, manage, and process data. Computing device 110 may comprise any number of servers, and may include any type and number of other resources, including resources that facilitate communications with and between the servers, storage by the servers, etc. (e.g., network switches, storage devices, networks, etc.).

After receiving alert 118, a user may view alert 118 via computing device 108. Alert 118 may provide a limited amount of information regarding the suspicious activity. To view additional information and/or perform an action to mitigate the suspicious activity, the user may provide user input to activate the uniform resource identifier included in alert 118. For instance, the uniform resource identifier may comprise a hyperlink, when activated, causes browser application 122 to navigate to web-based portal 120. The hyperlink may be activated via different types of user input, including, but not limited to, a mouse click, touch-based input, copying-and-pasting the uniform resource identifier into an address bar of browser application 122, etc. When the hyperlink is activated, browser application 122 may provide a request (e.g., a hypertext transfer protocol (HTTP) request) to the web site on which web-based portal 120 is hosted. In response, the web site may provide a response (e.g., an HTTP response) comprising code (e.g., HTML (hypertext markup language), CSS (cascading) style sheets, etc.), which browser application 122 utilizes to perform the page layout and rendering of the content of web-based portal 120.

Web-based portal 120 may provide additional (or detailed) information related to the suspicious activity. For example, web-based portal 120 may provide access to logs 116 so that the user may analyze the activity that was flagged as being suspicious. Web-based portal 120 may also provide recommendations for actions for mitigating the suspicious activity. For instance, the recommendations may recommend for the user to block a certain IP address, disable network accessibility for the accessed resources, etc. Web-based portal 120 may also provide access to network services and/or options (e.g., firewalls, permission settings, etc.) that enable the user to perform actions to mitigate the suspicious activity.

Web-based portal 120 may comprise an activity tracker 124. Activity tracker 124 is configured to track the activity of a user while using web-based portal 120. For instance, activity tracker 124 may track which web pages of the web site via which web-based portal 120 is hosted are accessed and/or viewed by the user, track an amount of time the user has spent on web-based portal 120, track actions performed by the user to mitigate the suspicious, track actions performed with respect to application 102 and/or its associated resources, etc.

In accordance with an embodiment, activity tracker 124 initiates tracking responsive to a user activating the uniform resource identifier included in alert 118. For instance, upon receiving the request to access web-based portal 120 from browser application 110 or providing the response comprising the code of web-based portal 120 to browser application 110, activity tracker 124 may begin tracking. Activity tracker 124 may generate a session identifier that identifies the web-based portal session in which the user is currently engaging. The period in which a user has accessed web-based portal 120 via the uniform resource identifier included in alert 118 and logs off from web-based portal 120 may be referred to as a portal session.

Activity tracker 124 may also initiate a session timer upon a user accessing web-based portal 120. The session timer may be stopped after detecting a certain event. Such events include, but are not limited to, a user logging off from web-based portal 120, a user performing an action to mitigate the suspicious activity, expiration of a predetermined time period, etc. Activity tracker 124 may also be configured to obtain timestamps corresponding to times at which a user performs a particular activity via web-based portal 120. Such activities include, but is not limited to, logging into web-based portal 120, logging off web-based portal 120, accessing a particular web page of web-based portal 120, performing a particular action to mitigate the suspicious activity, etc. Activity tracker 124 may also be configured to initiate a timer after alert 118 is provided to the user. This way, activity tracker 124 may be able to track an amount of time it takes for the user to access web-based portal 120 after receiving alert 118. Each of the activities performed and tracked by the user via web-based portal 124 may be associated with the session identifier.

In certain situations, a user may not access web-based portal 120 via the uniform resource identifier included in alert 118. That is, the user may decide to log into web-based portal 120 via browser application 122 without activating the uniform resource identifier included in alert 118. In such situations, activity tracker 124 may be configured to heuristically correlate a portal session with alert 118. For instance, activity tracker 124 may infer that a user is engaging in a portal session responsive to receiving alert 118 based on various criteria. The criteria may include an amount of time between receiving alert 118 and when the user logs into web-based portal 120. If the amount of time between receiving alert 118 and the user logging into web-based portal 120 is below a predetermined threshold (e.g., 2 hours), then activity tracker 124 may determine that the user has logged into web-based portal 120 responsive to receiving alert 118. The criteria may also include the applications (e.g., application 110) and/or resources accessed and/or managed by the user. For instance, if the application and/or resources are the same as the application and/or resources identified by alert 118, then activity tracker 124 may determine that the user has logged into web-based portal 120 responsive to receiving alert 118. The criteria may further include the actions performed by the user to mitigate suspicious activity. For instance, if the user performs mitigating actions in relation to the application and/or resources identified by alert 118, then activity tracker 124 may determine that the user has logged into web-based portal 120 responsive to receiving alert 118. Responsive to detecting a combination of one or more of such criteria, activity tracker 124 may begin tracking the user’s activity as described above.

In accordance with one or more embodiments, the action(s) performed by the user to mitigate the suspicious activity may be saved and provided as recommendations (e.g., via web-based portal 120 and/or in an alert itself) for subsequent alerts identifying similar activity that are issued by alert generator 106.

Activity tracker 124 is configured to analyze the tracked activity and generate an actionability metric (or ranking) for alert 118. The actionability metric indicates a level of interaction between the user and alert 118. For example, a first level of interaction may indicate that a user viewed alert 118 and performed action(s) to mitigate the suspicious activity. Such a level attributes a relatively high value to alert 118, as alert 118 indicated activity that was in fact (or likely) malicious and led to efficient execution of correct mitigation steps by the user.

Activity tracker 124 may designate the first level of interaction for alert 118 responsive to determining that a first length of time between a user activating the uniform resource identifier included in alert 118 and the user performing action(s) to mitigate the suspicious activity is below a predetermined threshold (e.g., 1 hour). Alternatively, activity tracker 124 may designate the first level of interaction to alert 118 responsive to determining that a second length of time between a user logging into web-based portal 120 and the user performing action(s) to mitigate the suspicious activity is below the predetermined threshold. Activity tracker 124 may utilize the timer values and/or timestamps, as described above, to determine the first and/or second lengths of time. For instance, activity tracker 124 may compare a timer value generated by a timer of activity tracker 124 (that keeps tracks of how long it takes the user to perform action(s) to mitigate the suspicious activity) to the predetermined threshold. If the timer value is below the predetermined threshold, activity tracker 124 may generate an actionability metric indicative of the of the first level of interaction. In another example, activity tracker 124 may determine the difference of a first timestamp indicative of a user activating the uniform resource identifier included in alert 118 (or alternatively, indicative of a user logging into web-based portal 120) and a second timestamp indicative of the when the user performed action(s) to mitigate the suspicious activity. Activity tracker 124 may compare the difference to the predetermined threshold. If the difference is below the predetermined threshold, activity tracker 124 may generate an actionability metric indicative of the of the first level of interaction.

A second level of interaction may indicate that a user viewed alert 118, but that the user spent too much time on web-based portal 120 reviewing logs 116, took too much time to perform action(s) to mitigate the suspicious activity, or performed no action(s) to mitigate the suspicious activity. Such a level attributes a relatively medium value to alert 118, as alert 118 likely indicated activity that was not in fact (or likely not) malicious (i.e., the activity was likely benign).

Activity tracker 124 may designate the second level of interaction for alert 118 responsive to determining at least one that the amount of time the user has spent on web-based portal 120 exceeds a predetermined threshold (e.g., 2 hours) or that the user has not performed the action to mitigate the suspicious activity within a predetermined period of time (e.g., 2 hours). Activity tracker 124 may utilize the timer values and timestamps to determine the amount of time and/or time periods. For instance, activity tracker 124 may compare a timer value generated by session timer of activity tracker 124 (that keeps tracks of how long the user has been logged into web-based portal 120) to the predetermined threshold. If the timer value exceeds the predetermined threshold, activity tracker 124 may generate an actionability metric indicative of the of the second level of interaction. In addition, activity tracker 124 may determine whether the user has performed action(s) to mitigate the suspicious activity. If the indication is not received within the predetermined period of time, activity tracker 124 may generate an actionability metric indicative of the of the second level of interaction.

A third level of interaction may indicate that a user did not interact with alert 118 (e.g., the user did not activate the uniform resource identifier included in alert 118 and/or performed no activity with respect to application 102 and/or the resource(s) identified by alert 118). Such a level attributes a relatively low value to alert 118, as alert 118 indicated activity that was not in fact malicious (i.e., the activity was benign).

Activity tracker 124 may designate the third level of interaction for alert 118 responsive to determining that the uniform resource identifier included in alert 118 has not been activated by the user (or alternatively, that the user performed no action to mitigate the suspicious activity) within a predetermined period of time (e.g., 5 days). Activity tracker 124 may utilize the timer values and timestamps to make this determination. For instance, activity tracker 124 may determine that the user did not activate the uniform resource identifier included in alert 118 (or alternatively, did not perform any action to mitigate the suspicious activity) within the predetermined period of time. The determination may be made responsive to a timer maintained by activity tracker 124 timing out. Responsive to receiving the indication, activity tracker 124 may generate an actionability metric indicative of the of the third level of interaction.

The determined actionability metrics are provided to label generator 112. Label generator 112 is configured to generate labels for the log data of logs 116 stored in data store 104 (shown as labeled logs 116′). In accordance with an embodiment, label generator 112 may be configured to label logs 116 on a periodic basis (e.g., once a day, once a week, once a month, etc.). In accordance with an embodiment, label generator 112 may be configured to label logs 116 responsive to receiving a command (e.g., via user input). Labels are based on the actionability metrics determined for alerts (e.g., alert 118). Alerts having an actionability metric indicating the first level of interaction may be labeled as being indicative of suspicious activity. Alerts having an actionability metric indicating the second or third level of interaction may be labeled as being indicative of benign activity. For instance, if an actionability metric for alert 118 is determined to be the first level of interaction, label generator 112 generates and assigns a label to the log data on which alert 118 was generated that indicates that the transactions represented by the log data are indicative of suspicious activity. If an actionability metric for alert 118 is determined to be the second or third level of interaction, label generator 112 generates and assigns a label to the log data on which alert 118 was generated that indicates that the transactions represented by the log data are indicative of benign activity. The label may indicate whether the log data is indicative of malicious activity or benign activity. In certain cases (e.g., in the absence of malicious or benign indicators), the actionability metrics themselves may be utilized as the labels. That is, the determined level of interaction may be utilized as the label for the log data.

In an embodiment in which logs 116 are maintained via database table(s), label generator 112 may label a log of logs 116 by storing the generated label in a column of the table in which the log is stored. For instance, label generator 116 may add a column to the row(s) in which the log is stored and store the generated label in the newly-added column.

Labelled logs 116′ are utilized to train supervised machine learning algorithm 114. Supervised machine learning algorithm 114 is configured to learn what constitutes suspicious activity with respect to application 102 and its associated resources using logs of logs 116 labeled as being indicative of suspicious activity and logs of logs 116 labeled as being indicative of benign activity. For instance, labeled logs 116′ may be provided to supervised machine learning algorithm 114 as training data. The training data may comprise positively-labeled logs of labeled logs 116′ (e.g., logs labeled as being indicative of suspicious activity) and negatively-labeled logs of labeled logs 116′ (e.g., logs labeled as being indicative of benign activity). Positively-labeled logs of labeled logs 116′ is provided as a first input to supervised machine learning algorithm 114, and negatively-labeled logs of labeled logs 116′ is provided as a second input to supervised machine learning algorithm 114. Using these inputs, supervised machine learning algorithm 114 learns what constitutes suspicious activity and generates a supervised machine learning model 126 that is utilized to classify newly-generated logs as being indicative of suspicious activity or benign activity.

After the training process is complete, supervised machine learning model 126 may output an indication (e.g., a prediction) as to whether inputted log data of newly-generated logs is indicative of suspicious activity. In accordance with an embodiment, the indication outputted by supervised machine learning model 126 is a probability that the log provided thereto is indicative of suspicious activity. If the probability exceeds a predetermined threshold (e.g., 0.90), alert generator 106 may determine that suspicious activity has occurred and generate an alert as described above. If the probability does not exceed the threshold, alert generator 106 may determine that suspicious activity has not occurred and not generate an alert.

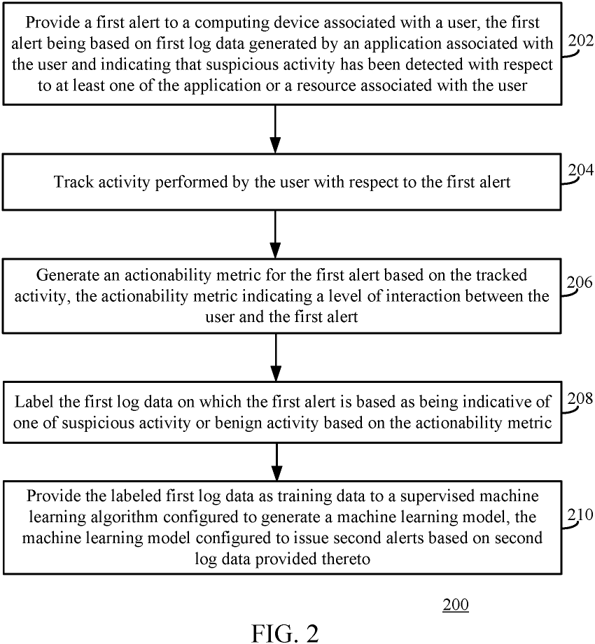

Accordingly, labels may be generated based on alerts and used to train a machine learning algorithm for generating improved alerts in many ways. For example, FIG. 2 shows a flowchart 200 of a method for generating labels based on alerts and training a machine learning algorithm for generating improved alerts based on such labels in accordance with an example embodiment. In an embodiment, flowchart 200 may be implemented by system 100 of FIG. 1. Accordingly, flowchart 200 will be described with continued reference to FIG. 1. Other structural and operational embodiments will be apparent to persons skilled in the relevant art(s) based on the discussion regarding flowchart 200 and system 100 of FIG. 1.

Flowchart 200 begins with step 202. In step 202, a first alert is provided to a computing device associated with a user. The first alert is based on first log data generated by an application associated with the user and indicates that suspicious activity has been detected with respect to at least one of the application or a resource associated with the user. For example, with reference to FIG. 1, alert generator 106 provides alert 118 to computing device 108. Alert 108 is based on first log data of a log of logs 116 generated by application 102 and indicates that suspicious activity has been detected with respect to at least one of application 102 or a resource associated with the user.

In accordance with one or more embodiments, the first alert is generated by an unsupervised machine learning model. For example, with reference to FIG. 1, alert 118 may be generated by unsupervised machine learning model 128.

In accordance with one or more embodiments, the first alert comprises at least one of an identifier of the application, an identifier of the resource, or a uniform resource identifier of a web-based portal, the web-based portal enabling the user to perform at least one of view details regarding the first alert or perform an action to mitigate the suspicious activity. For example, with reference to FIG. 1, alert 118 may comprise at least one of an identifier of application 102, an identifier of the resource, or a uniform resource identifier of web-based portal 120. Web-based portal 120 enables the user to perform at least one of view details regarding the first alert or perform an action to mitigate the suspicious activity.

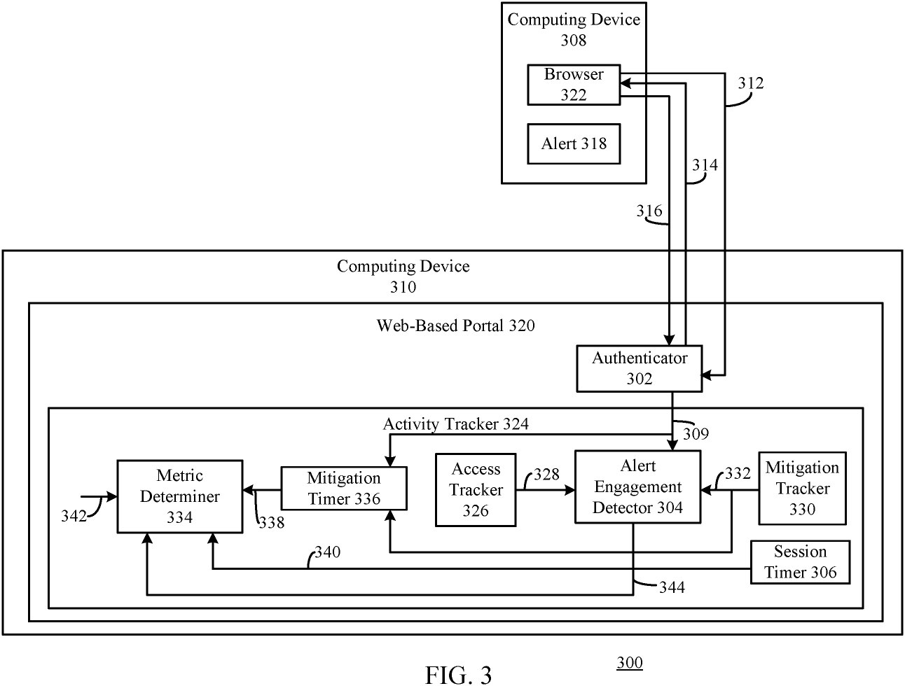

In step 204, activity performed by the user with respect to the first alert is tracked. For example, with reference to FIG. 1, activity tracker 124 tracks activity performed by the user with respect to alert 118. Additional details regarding activity tracking are described below with reference to FIG. 3.

In step 206, an actionability metric is generated for the first alert based on the tracked activity. The actionability metric indicates a level of interaction between the user and the first alert. For example, with reference to FIG. 1, activity tracker 124 generates an actionability metric for alert 118 based on the activity tracked thereby. Additional details regarding generating actionability metrics are described below with reference to FIGS. 3-6.

In step 208, the first log data on which the first alert is based is labeled as being indicative of one of suspicious activity or benign activity based on the actionability metric. For example, with reference to FIG. 1, label generator 112 labels the first log data from the log of logs 116 on which alert 118 is based (shown as labeled logs 116′) as being indicative of one of suspicious activity or benign activity based on the actionability metric.

In step 210, the labeled first log data is provided as training data to a supervised machine learning algorithm configured to generate a machine learning model. The machine learning model is configured to issue second alerts based on second log data provided thereto. For example, with reference to FIG. 1, labeled logs 116′ are provided as training data to supervised machine learning algorithm 114 configured to generate supervised machine learning model 126. Supervised machine learning model 126 is configured to issue second alerts based on second log data provided thereto.

In accordance with one or more embodiments, activity tracking comprises receiving an indication that the user has engaged with the alert, and responsive to receiving the indication, monitoring an amount of time the user has spent on the web portal and determining whether the user has performed the action to mitigate the suspicious activity. For example, FIG. 3 depicts a block diagram of a system 300 configured to track activity performed by a user with respect to an alert, according to an example embodiment. As shown in FIG. 3, system 300 comprises a computing device 308 and a computing device 310. Computing device 308 and computing device 310 are examples of computing device 108 and computing device 110, as respectively described above with reference to FIG. 1. Computing device 308 is configured to display an alert 318 and execute a browser application 322. Alert 318 and browser application 322 are examples of alert 118 and browser application 122, as respectively described above with reference to FIG. 1. Computing device 310 is configured to host a web-based portal 320, which is an example of web-based portal 120, as described above with reference to FIG. 1. Web-based portal 320 may comprise an authenticator 302 and an activity tracker 324. Activity tracker 324 is an example of activity tracker 124, as described above with reference to FIG. 1. Activity tracker 324 may comprise an alert engagement detector 304, a session timer 306, an access tracker 326, a mitigation tracker 330, a metric determiner 334, and a mitigation timer 336.

Alert engagement detector 304 of activity tracker 324 is configured to receive one or more indications 309, 328, and/or 332 that the user has engaged with alert 318. Indication 309 is provided by authenticator 302. Authenticator 302 is configured to authenticate a user with web-based portal 320. The first time a user navigates to web-based portal 320 (either via activating the uniform resource identifier included in alert 318 or directly via browser application 322), browser application 322 may provide a request 312 (e.g., an HTTP request) to a sign-in page associated with web-based portal 320, where the user is prompted to enter authentication (e.g., sign-in) credentials for web-based portal 320. Examples of authentication credentials include, but are not limited to, a username, a password, a personal identification number (PIN), biometric information, a passphrase, etc. Authenticator 302 may be configured to validate the authentication credentials. Upon successful validation, authenticator 302 may provide indication 309 to alert engagement detector 304. Authenticator 302 may also provide an access token to browser application 322 via a response 314 (e.g., an HTTP response). During subsequent navigations to web-based portal 320 (either via activating the uniform resource identifier included in alert 318 or directly via browser application 322), browser application 322 may provide the access token to authenticator 302 via a request 316, and authenticator 302 validates the access token. Upon successful validation, authenticator 302 provides indication 309 to alert engagement detector 304.

In accordance with one or more embodiments, the indication indicating that the user has engaged with an alert is received responsive to a user activating the uniform resource identifier. For example, with reference to FIG. 3, responsive to a user activating the uniform resource identifier included in alert 318, browser application 322 may provide request 316 comprising the access token. Responsive to validating the access token, authenticator 302 provides indication 309 to alert engagement detector 304.

Responsive to receiving indication 309, an amount of time the user has spent on the web portal is monitored. The determined amount of time may be utilized to generate the actionability metric, as will be further described below. For example, with reference to FIG. 3, session timer 306 is utilized to track an amount of time the user has spend on web-based portal 320.

Responsive to receiving indication 309, a determination may also be made as to whether the user has performed the action to mitigate the suspicious activity. For example, with reference to FIG. 3, and as described above, web-based portal 320 may provide access to resources (e.g., firewalls, network permissions, etc.) that enable the user to mitigate the suspicious activity. Mitigation tracker 330 of activity tracker 324 is configured to track and/or monitor such access (e.g., by monitoring actions (e.g., user interface (e.g., menu options, buttons, etc.) interactions and/or the like) and determine that the user has performed an action to mitigate the suspicious activity with respect to the application and/or resource identified by alert 318.

In accordance with one or more embodiments, the indication indicating that the user has engaged with an alert is received in response to heuristically determining that a user is engaging with an alert even though the user did not activate the uniform resource identifier included in the alert. For example, the indication may be received responsive to at least one of determining that the user has logged into the web portal, determining that the user has interacted with at least one of the application or the resource identified by the alert, or determining that the user has performed the action to mitigate the suspicious activity. For instance, with reference to FIG. 3, indication 309 may be received responsive to a user logging into web-based portal 320. In another example, access tracker 326 may provide an indication 328 to alert engagement detector 304 indicating the user has engaged with alert 318 in response to determining that the user has interacted with at least one of the application (e.g., application 102, as shown in FIG. 2) or the resource (e.g., associated with the application) identified by alert 318. As described above, web-based portal 320 may provide access to the application and its associated resources. Access tracker 326 of activity tracker 324 is configured to track and/or monitor such access (e.g., by monitoring actions (e.g., user interface (e.g., menu options, buttons, etc.) interactions and/or the like) taken by the user via the user interface of web-based portal 320) and provides indication 328 to alert engagement detector 304 indicating as such. In yet another example, mitigation tracker 330 may provide an indication 332 to alert engagement detector 304 indicating the user has engaged with alert 318 in response to determining that the user has performed action(s) to mitigate the suspicious activity. Mitigation tracker 330 of activity tracker 324 may provide indication 332 indicating that the user has performed action(s) to mitigate the suspicious activity.

It is noted that alert engagement detector 304 may be configured to determine that a user has engaged with alert 318 based on any combination of indication 309, indication 328, and indication 332.

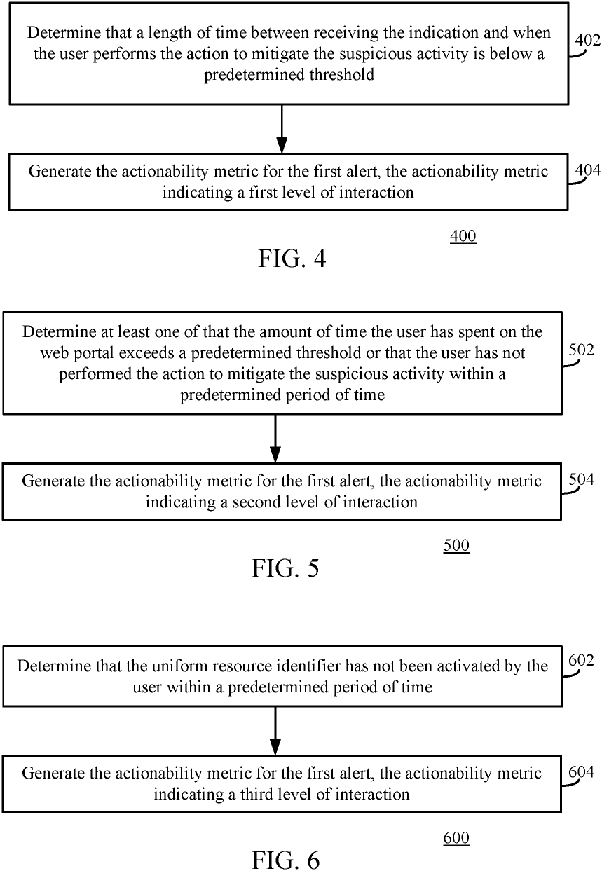

FIG. 4 shows a flowchart 400 of a method for generating an actionability metric in accordance with an example embodiment. In an embodiment, flowchart 400 may be implemented by system 300 of FIG. 3. Accordingly, flowchart 400 will be described with continued reference to FIG. 3. Other structural and operational embodiments will be apparent to persons skilled in the relevant art(s) based on the discussion regarding flowchart 400 and system 300 of FIG. 3.

Flowchart 400 begins with step 402. In step 402, a determination is made that a length of time between receiving the indication and when the user performs the action to mitigate the suspicious activity is below a predetermined threshold. For example, with reference to FIG. 3, mitigation timer 336 may be configured to receive indication 309 (indicating when a user has logged into web-based portal 320 and is engaging in a web-based portal session) and indication 332 (indicating that the user has performed an action to mitigate the suspicious activity). Mitigation timer 336 may be initiated responsive to receiving indication 309 and stopped responsive to receiving indication 332. After mitigation timer 336 is stopped, mitigation timer 336 may provide the resulting timer value (shown as timer value 338) to metric determiner 334. Metric determiner 334 is configured to determine whether the timer value 338 is below a predetermined threshold (e.g., 1 hour).

In step 404, responsive to determining that the length of time is below the predetermined threshold, the actionability metric is generated for the first alert, the actionability metric indicating a first level of interaction. For example, with reference to FIG. 3, responsive to determining that the length of time is below the predetermined threshold, metric determiner 334 generates the actionability metric for alert 318, the actionability metric indicating the first level of interaction, as described above.

FIG. 5 shows a flowchart 500 of a method for generating an actionability metric in accordance with another example embodiment. In an embodiment, flowchart 500 may be implemented by system 300 of FIG. 3. Accordingly, flowchart 500 will be described with continued reference to FIG. 3. Other structural and operational embodiments will be apparent to persons skilled in the relevant art(s) based on the discussion regarding flowchart 500 and system 300 of FIG. 3.

Flowchart 500 begins with step 502. In step 502, a determination is made that at least one of the amount of time the user has spent on the web portal exceeds a predetermined threshold or that the user has not performed the action to mitigate the suspicious activity within a predetermined period of time. For example, with reference to FIG. 3, session timer 306 may be configured to provide a running timer value 340 to metric determiner 334. Metric determiner 334 is configured to determine whether timer value 340 exceeds the predetermined threshold and/or configured to determine whether mitigation timer 336 provides timer value 338 within a predetermined period of time.

In step 504, responsive to at least one of determining that the amount of time exceeds the predetermined threshold or determining that the user has not performed the action within the predetermined period of time, the actionability metric is generated for the first alert, the actionability metric indicating a second level of interaction. For example, with reference to FIG. 3, responsive to at least one of determining that the amount of time exceeds the predetermined threshold or determining that the user has not performed the action within the predetermined period of time, metric determiner 334 generates the actionability metric for alert 318, the actionability metric indicating the second level of interaction, as described above.

FIG. 6 shows a flowchart 600 of a method for generating an actionability metric in accordance with another example embodiment. In an embodiment, flowchart 600 may be implemented by system 600 of FIG. 3. Accordingly, flowchart 600 will be described with continued reference to FIG. 3. Other structural and operational embodiments will be apparent to persons skilled in the relevant art(s) based on the discussion regarding flowchart 500 and system 300 of FIG. 3.

Flowchart 600 begins with step 602. In step 602, a determination is made that the uniform resource identifier has not been activated by the user within a predetermined period of time. For example, with reference to FIG. 3, metric determiner 334 may be configured to receive an indication 342 from alert generator 106 (as shown in FIG. 1) that an alert was provided to the user. Metric determiner 334 may also receive an indication 344 from alert engagement detector 304 responsive to alert engagement detector 304 receiving one or more of indications 309, 328, 332. If metric determiner 334 does not receive indication 344 within the predetermined period of time after receiving indication 342, then metric determiner 334 determines that the uniform resource identifier included in alert 318 has not been activated by the user within the predetermined period of time.

In step 604, responsive to determining that uniform resource identifier has not been activated within the predetermined period of time, the actionability metric is generated for the first alert, the actionability metric indicating a third level of interaction. For example, with reference to FIG. 3, responsive to determining that uniform resource identifier has not been activated within the predetermined period of time, metric determiner 334 generates the actionability metric for alert 318, the actionability metric indicating the third level of interaction, as described above.

Referring again to FIG. 1, label determiner 112 utilizes the metrics generated for alerts to label first log data associated with the logs. In accordance with one or more embodiments, labeling the log data comprises one of labeling the first log data as being indicative of suspicious activity based on the actionability metric indicating the first level of interaction, or labeling the first log data as being indicative of benign activity based on the actionability metric indicating at least one of the second level of interaction or the third level of interaction. For example, with reference to FIG. 1, label determiner 112 labels the first log data of logs 116 as being indicative of suspicious activity based on the actionability metric indicating the first level of interaction or labels the first log data of logs 112 as being indicative of benign activity based on the actionability metric indicating at least one of the second level of interaction or the third level of interaction.

### III. Example Computer System Implementation

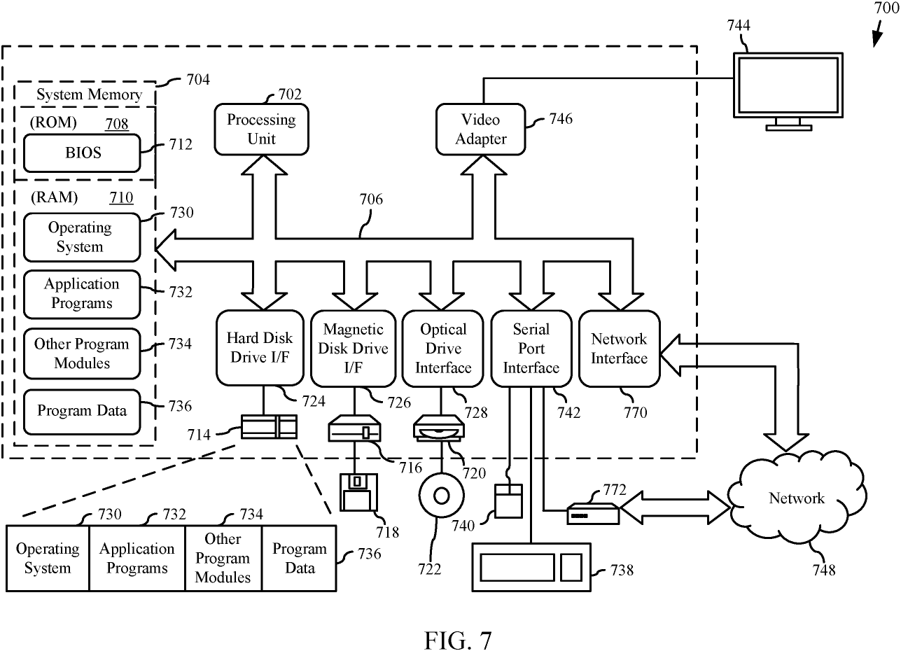

The systems and methods described above in reference to FIGS. 1-6, may be implemented in hardware, or hardware combined with one or both of software and/or firmware. For example, system 700 of FIG. 7 may be used to implement any of application 102, data store 104, alert generator 106, unsupervised machine learning model 128, supervised machine learning model 126, computing device 108, browser application 122, computing device 110, web-based portal 120, activity tracker 124, label generator 112, supervised machine learning algorithm 114, computing device 308, browser application 322, computing device 310, web-based portal 320, authenticator 302, activity tracker 324, alert engagement detector 304, mitigating tracker 330, session timer 306, access tracker 326, mitigation timer 336, and/or metric determiner 334, and/or any of the components respectively described therein, and flowcharts 200, 400, 500, and/or 600 may be each implemented as computer program code/instructions configured to be executed in one or more processors and stored in a computer readable storage medium. Alternatively, any of application 102, data store 104, alert generator 106, unsupervised machine learning model 128, supervised machine learning model 126, computing device 108, browser application 122, computing device 110, web-based portal 120, activity tracker 124, label generator 112, supervised machine learning algorithm 114, computing device 308, browser application 322, computing device 310, web-based portal 320, authenticator 302, activity tracker 324, alert engagement detector 304, mitigating tracker 330, session timer 306, access tracker 326, mitigation timer 336, and/or metric determiner 334, and/or any of the components respectively described therein, and flowcharts 200, 400, 500, and/or 600 may be implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions. The description of system 700 provided herein is provided for purposes of illustration, and is not intended to be limiting. Embodiments may be implemented in further types of computer systems, as would be known to persons skilled in the relevant art(s).

As shown in FIG. 7, system 700 includes a processing unit 702, a system memory 704, and a bus 706 that couples various system components including system memory 704 to processing unit 702. Processing unit 702 may comprise one or more circuits, microprocessors or microprocessor cores. Bus 706 represents one or more of any of several types of bus structures, including a memory bus or memory controller, a peripheral bus, an accelerated graphics port, and a processor or local bus using any of a variety of bus architectures. System memory 704 includes read only memory (ROM) 708 and random access memory (RAM) 710. A basic input/output system 712 (BIOS) is stored in ROM 708.

System 700 also has one or more of the following drives: a hard disk drive 714 for reading from and writing to a hard disk, a magnetic disk drive 716 for reading from or writing to a removable magnetic disk 718, and an optical disk drive 720 for reading from or writing to a removable optical disk 722 such as a CD ROM, DVD ROM, BLU-RAY™ disk or other optical media. Hard disk drive 714, magnetic disk drive 716, and optical disk drive 720 are connected to bus 706 by a hard disk drive interface 724, a magnetic disk drive interface 726, and an optical drive interface 728, respectively. The drives and their associated computer-readable media provide nonvolatile storage of computer-readable instructions, data structures, program modules and other data for the computer. Although a hard disk, a removable magnetic disk and a removable optical disk are described, other types of computer-readable memory devices and storage structures can be used to store data, such as solid state drives, flash memory cards, digital video disks, random access memories (RAMs), read only memories (ROM), and the like.

A number of program modules may be stored on the hard disk, magnetic disk, optical disk, ROM, or RAM. These program modules include an operating system 730, one or more application programs 732, other program modules 734, and program data 736. In accordance with various embodiments, the program modules may include computer program logic that is executable by processing unit 702 to perform any or all of the functions and features of any of application 102, data store 104, alert generator 106, unsupervised machine learning model 128, supervised machine learning model 126, computing device 108, browser application 122, computing device 110, web-based portal 120, activity tracker 124, label generator 112, supervised machine learning algorithm 114, computing device 308, browser application 322, computing device 310, web-based portal 320, authenticator 302, activity tracker 324, alert engagement detector 304, mitigating tracker 330, session timer 306, access tracker 326, mitigation timer 336, and/or metric determiner 334, and/or any of the components respectively described therein, and flowcharts 200, 400, 500, and/or 600, as described above. The program modules may also include computer program logic that, when executed by processing unit 702, causes processing unit 702 to perform any of the steps of any of the flowcharts of FIGS. 2 and 4-6, as described above.

A user may enter commands and information into system 700 through input devices such as a keyboard 738 and a pointing device 740 (e.g., a mouse). Other input devices (not shown) may include a microphone, joystick, game controller, scanner, or the like. In one embodiment, a touch screen is provided in conjunction with a display 744 to allow a user to provide user input via the application of a touch (as by a finger or stylus for example) to one or more points on the touch screen. These and other input devices are often connected to processing unit 702 through a serial port interface 742 that is coupled to bus 706, but may be connected by other interfaces, such as a parallel port, game port, or a universal serial bus (USB). Such interfaces may be wired or wireless interfaces.

Display 744 is connected to bus 706 via an interface, such as a video adapter 746. In addition to display 744, system 700 may include other peripheral output devices (not shown) such as speakers and printers.

System 700 is connected to a network 748 (e.g., a local area network or wide area network such as the Internet) through a network interface 750, a modem 752, or other suitable means for establishing communications over the network. Modem 752, which may be internal or external, is connected to bus 706 via serial port interface 742.

As used herein, the terms “computer program medium,” “computer-readable medium,” and “computer-readable storage medium” are used to generally refer to memory devices or storage structures such as the hard disk associated with hard disk drive 714, removable magnetic disk 718, removable optical disk 722, as well as other memory devices or storage structures such as flash memory cards, digital video disks, random access memories (RAMs), read only memories (ROM), and the like. Such computer-readable storage media are distinguished from and non-overlapping with communication media and modulated data signals (do not include communication media or modulated data signals). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media. Embodiments are also directed to such communication media that are separate and non-overlapping with embodiments directed to computer-readable storage media.

As noted above, computer programs and modules (including application programs 732 and other program modules 734) may be stored on the hard disk, magnetic disk, optical disk, ROM, or RAM. Such computer programs may also be received via network interface 750, serial port interface 742, or any other interface type. Such computer programs, when executed or loaded by an application, enable system 700 to implement features of embodiments discussed herein. Accordingly, such computer programs represent controllers of the system 700.

Embodiments are also directed to computer program products comprising software stored on any computer useable medium. Such software, when executed in one or more data processing devices, causes a data processing device(s) to operate as described herein. Embodiments may employ any computer-useable or computer-readable medium, known now or in the future. Examples of computer-readable mediums include, but are not limited to memory devices and storage structures such as RAM, hard drives, solid state drives, floppy disks, CD ROMs, DVD ROMs, zip disks, tapes, magnetic storage devices, optical storage devices, MEMs, nanotechnology-based storage devices, and the like.

### IV. Further Example Embodiments

A system comprising at least one processor circuit and at least one memory that stores program configured to be executed by the at least one processor circuit. The program code comprises as an alert generator, an activity tracker, and a label generator. The alert generator is configured to provide a first alert to a computing device associated with a user, the first alert being based on first log data generated by an application associated with the user and indicating that suspicious activity has been detected with respect to at least one of the application or a resource associated with the user; the activity tracker is configured to: track activity performed by the user with respect to the first alert; and generate an actionability metric for the first alert based on the tracked activity, the actionability metric indicating a level of interaction between the user and the first alert; the label generator is configured to label the first log data on which the first alert is based as being indicative of one of suspicious activity or benign activity based on the actionability metric, the labeled first log data being provided as training data to a supervised machine learning algorithm configured to generate a machine learning model, the machine learning model configured to issue second alerts based on second log data provided thereto.

In one implementation of the foregoing system, the first alert is generated by an unsupervised machine learning model.

In one implementation of the foregoing system, the first alert comprises at least one of an identifier of the application, an identifier of the resource, or a uniform resource identifier of a web-based portal, the web-based portal enabling the user to perform at least one of: view details regarding the first alert; or perform an action to mitigate the suspicious activity.

In one implementation of the foregoing system, the activity tracker is configured to: receive an indication that the user has engaged with the alert; and responsive to receiving the indication: monitor an amount of time the user has spent on the web portal; and determine whether the user has performed the action to mitigate the suspicious activity.

In one implementation of the foregoing system, the indication is received responsive to a user activating the uniform resource identifier.

In one implementation of the foregoing system, the indication is received responsive to at least one of: a determination that the user has logged into the web portal; a determination that the user has interacted with at least one of the application or the resource identified by the alert; or a determination that the user has performed the action to mitigate the suspicious activity

In one implementation of the foregoing system, the activity tracker is configured to: determine that a length of time between receiving the indication and when the user performs the action to mitigate the suspicious activity is below a predetermined threshold; and responsive to a determination that the length of time is below the predetermined threshold, generate the actionability metric for the first alert, the actionability metric indicating a first level of interaction.

A method is also described herein. The method includes: providing a first alert to a computing device associated with a user, the first alert being based on first log data generated by an application associated with the user and indicating that suspicious activity has been detected with respect to at least one of the application or a resource associated with the user; tracking activity performed by the user with respect to the first alert; generating an actionability metric for the first alert based on the tracked activity, the actionability metric indicating a level of interaction between the user and the first alert; labeling the first log data on which the first alert is based as being indicative of one of suspicious activity or benign activity based on the actionability metric; and providing the labeled first log data as training data to a supervised machine learning algorithm configured to generate a machine learning model, the machine learning model configured to issue second alerts based on second log data provided thereto.

In one implementation of the foregoing method, the first alert is generated by an unsupervised machine learning model.

In another implementation of the foregoing method, the first alert comprises at least one of an identifier of the application, an identifier of the resource, or a uniform resource identifier of a web-based portal, the web-based portal enabling the user to perform at least one of: view details regarding the first alert; or perform an action to mitigate the suspicious activity.

In another implementation of the foregoing method, said tracking comprises: receiving an indication that the user has engaged with the alert; and responsive to receiving the indication: monitoring an amount of time the user has spent on the web portal; and determining whether the user has performed the action to mitigate the suspicious activity.

In another implementation of the foregoing method, the indication is received responsive to a user activating the uniform resource identifier.

In another implementation of the foregoing method, the indication is received responsive to at least one of: determining that the user has logged into the web portal; determining that the user has interacted with at least one of the application or the resource identified by the alert; or determining that the user has performed the action to mitigate the suspicious activity.

In another implementation of the foregoing method, generating the actionability metric comprises: determining that a length of time between receiving the indication and when the user performs the action to mitigate the suspicious activity is below a predetermined threshold; and responsive to determining that the length of time is below the predetermined threshold, generating the actionability metric for the first alert, the actionability metric indicating a first level of interaction.

In another implementation of the foregoing method, generating the actionability metric comprises: determining at least one of: that the amount of time the user has spent on the web portal exceeds a predetermined threshold; or that the user has not performed the action to mitigate the suspicious activity within a predetermined period of time; and responsive to at least one of determining that the amount of time exceeds the predetermined threshold or determining that the user has not performed the action within the predetermined period of time, generating the actionability metric for the first alert, the actionability metric indicating a second level of interaction;

In another implementation of the foregoing method, said tracking comprises: determining that the uniform resource identifier has not been activated by the user within a predetermined period of time.

In another implementation of the foregoing method, generating the actionability metric comprises: responsive to determining that uniform resource identifier has not been activated within the predetermined period of time, generating the actionability metric for the first alert, the actionability metric indicating a third level of interaction.

In another implementation of the foregoing method, labeling the first log data comprises one of: labeling the first log data as being indicative of suspicious activity based on the actionability metric indicating the first level of interaction; or labeling the first log data as being indicative of benign activity based on the actionability metric indicating at least one of the second level of interaction or the third level of interaction.

A computer-readable storage medium having program instructions recorded thereon that, when executed by at least one processor, perform a method. The method includes: providing a first alert to a computing device associated with a user, the first alert being based on first log data generated by an application associated with the user and indicating that suspicious activity has been detected with respect to at least one of the application or a resource associated with the user; tracking activity performed by the user with respect to the first alert; generating an actionability metric for the first alert based on the tracked activity, the actionability metric indicating a level of interaction between the user and the first alert; labeling the first log data on which the first alert is based as being indicative of one of suspicious activity or benign activity based on the actionability metric; and providing the labeled first log data as training data to a supervised machine learning algorithm configured to generate a machine learning model, the machine learning model configured to issue second alerts based on second log data provided thereto.

In another implementation of the foregoing computer-readable storage medium, the first alert comprises at least one of an identifier of the application, an identifier of the resource, or a uniform resource identifier of a web-based portal, the web-based portal enabling the user to perform at least one of: view details regarding the first alert; or perform an action to mitigate the suspicious activity.

### V. Conclusion

While various example embodiments have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosure should not be limited by any of the above-described example embodiments, but should be defined only in accordance with the following claims and their equivalents.

What is claimed is:

1. A system, comprising:
at least one processor circuit; and
at least one memory that stores program code configured to be executed by the at least one processor circuit, the program code comprising:
an alert generator configured to provide a first alert to a computing device associated with a user, the first alert being based on first log data generated by an application associated with the user and indicating that suspicious activity has been detected with respect to at least one of the application or a resource associated with the user;
an activity tracker configured to:
track activity performed by the user with respect to the first alert; and
generate an actionability metric for the first alert based on the tracked activity, the actionability metric indicating a level of interaction between the user and the first alert;
a label generator configured to label the first log data on which the first alert is based as being indicative of one of suspicious activity or benign activity based on the actionability metric, the labeled first log data being provided as training data to a supervised machine learning algorithm configured to generate a machine learning model, the machine learning model configured to issue second alerts based on second log data provided thereto.

2. The system of claim 1, wherein the first alert is generated by an unsupervised machine learning model.

3. The system of claim 1, wherein the first alert comprises at least one of an identifier of the application, an identifier of the resource, or a uniform resource identifier of a web-based portal, the web-based portal enabling the user to perform at least one of:
view details regarding the first alert; or
perform an action to mitigate the suspicious activity.

4. The system of claim 3, wherein the activity tracker is configured to:
receive an indication that the user has engaged with the alert; and
responsive to receiving the indication:
monitor an amount of time the user has spent on the web portal; and
determine whether the user has performed the action to mitigate the suspicious activity.

5. The system of claim 4, wherein the indication is received responsive to a user activating the uniform resource identifier.

6. The system of claim 4, wherein the indication is received responsive to at least one of:
a determination that the user has logged into the web portal;
a determination that the user has interacted with at least one of the application or the resource identified by the alert; or
a determination that the user has performed the action to mitigate the suspicious activity.

7. The system of claim 4, wherein the activity tracker is configured to:
determine that a length of time between receiving the indication and when the user performs the action to mitigate the suspicious activity is below a predetermined threshold; and
responsive to a determination that the length of time is below the predetermined threshold, generate the actionability metric for the first alert, the actionability metric indicating a first level of interaction.

8. A method, comprising:
providing a first alert to a computing device associated with a user, the first alert being based on first log data generated by an application associated with the user and indicating that suspicious activity has been detected with respect to at least one of the application or a resource associated with the user;
tracking activity performed by the user with respect to the first alert;
generating an actionability metric for the first alert based on the tracked activity, the actionability metric indicating a level of interaction between the user and the first alert;
labeling the first log data on which the first alert is based as being indicative of one of suspicious activity or benign activity based on the actionability metric; and
providing the labeled first log data as training data to a supervised machine learning algorithm configured to generate a machine learning model, the machine learning model configured to issue second alerts based on second log data provided thereto.

9. The method of claim 8, wherein the first alert is generated by an unsupervised machine learning model.

10. The method of claim 8, wherein the first alert comprises at least one of an identifier of the application, an identifier of the resource, or a uniform resource identifier of a web-based portal, the web-based portal enabling the user to perform at least one of:
view details regarding the first alert; or
perform an action to mitigate the suspicious activity.

11. The method of claim 10, wherein said tracking comprises:
receiving an indication that the user has engaged with the alert; and
responsive to receiving the indication:
monitoring an amount of time the user has spent on the web portal; and
determining whether the user has performed the action to mitigate the suspicious activity.

12. The method of claim 11, wherein the indication is received responsive to a user activating the uniform resource identifier.

13. The method of claim 11, wherein the indication is received responsive to at least one of:
determining that the user has logged into the web portal;
determining that the user has interacted with at least one of the application or the resource identified by the alert; or
determining that the user has performed the action to mitigate the suspicious activity.

14. The method of claim 11, wherein generating the actionability metric comprises:
determining that a length of time between receiving the indication and when the user performs the action to mitigate the suspicious activity is below a predetermined threshold; and
responsive to determining that the length of time is below the predetermined threshold, generating the actionability metric for the first alert, the actionability metric indicating a first level of interaction.

15. The method of claim 14, wherein generating the actionability metric comprises:
determining at least one of:
that the amount of time the user has spent on the web portal exceeds a predetermined threshold; or
that the user has not performed the action to mitigate the suspicious activity within a predetermined period of time; and
responsive to at least one of determining that the amount of time exceeds the predetermined threshold or determining that the user has not performed the action within the predetermined period of time, generating the actionability metric for the first alert, the actionability metric indicating a second level of interaction;.

16. The method of claim 15, wherein said tracking comprises:
determining that the uniform resource identifier has not been activated by the user within a predetermined period of time.

17. The method of claim 16, wherein generating the actionability metric comprises:
responsive to determining that uniform resource identifier has not been activated within the predetermined period of time, generating the actionability metric for the first alert, the actionability metric indicating a third level of interaction.

18. The method of claim 17, wherein labeling the first log data comprises one of:
labeling the first log data as being indicative of suspicious activity based on the actionability metric indicating the first level of interaction; or
labeling the first log data as being indicative of benign activity based on the actionability metric indicating at least one of the second level of interaction or the third level of interaction.

19. A computer-readable storage medium having program instructions recorded thereon that, when executed by at least one processor, perform a method, the method comprising:
providing a first alert to a computing device associated with a user, the first alert being based on first log data generated by an application associated with the user and indicating that suspicious activity has been detected with respect to at least one of the application or a resource associated with the user;
tracking activity performed by the user with respect to the first alert;
generating an actionability metric for the first alert based on the tracked activity, the actionability metric indicating a level of interaction between the user and the first alert;
labeling the first log data on which the first alert is based as being indicative of one of suspicious activity or benign activity based on the actionability metric; and
providing the labeled first log data as training data to a supervised machine learning algorithm configured to generate a machine learning model, the machine learning model configured to issue second alerts based on second log data provided thereto.

20. The computer-readable storage medium of claim 19, wherein the first alert comprises at least one of an identifier of the application, an identifier of the resource, or a uniform resource identifier of a web-based portal, the web-based portal enabling the user to perform at least one of:
view details regarding the first alert; or
perform an action to mitigate the suspicious activity.
